(19) United States
(12) Patent Application Publication
(10) Pub. No.: US 2011/0321097 A1
(43) Pub. Date: Dec. 29, 2011

(54) METHOD AND APPARATUS FOR THE INTUITIVE BROWSING OF CONTENT

(75) Inventor: Behram DaCosta, San Diego, CA (US)

(73) Assignees: SONY ELECTRONICS INC., Park Ridge, NJ (US); SONY CORPORATION, Tokyo (JP)

(21) Appl. No.: 13/169,018

(22) Filed: Jun. 27, 2011

Related U.S. Application Data
(62) Division of application No. 12/018,096, filed on Jan. 22, 2008.

(51) Int. Cl. H04N 21/431

(52) U.S. Cl. 725/41

(57) ABSTRACT

A method and apparatus are disclosed. The method comprises: associating a 3D object having first, second and third faces, with a theme; populating the first face with a first icon that represents the theme; populating the second face with a second icon, the second icon representing a first attribute of the theme; populating the third face with a third icon, the third icon representing a second attribute of the theme; generating a first perspective view of a three dimensional object, the first perspective view having the first and second faces but not the third face; displaying the first perspective view on a portion of a display; receiving a command; generating a second perspective view of the three dimensional object, the second perspective view having the third face; removing the first perspective view from the display; and displaying the second perspective view on the portion of the display.

### CROSS REFERENCE TO RELATED APPLICATION

This is a divisional application that claims priority to U.S. Application No. 12/018,096, filed Jan. 22, 2008, which is incorporated in its entirety herein by reference.

### BACKGROUND OF THE INVENTION

1. Field of the Invention

The present invention relates generally to Graphical User Interfaces (GUIs) for browsing content and executing functions, and more specifically to the windows, icons and other symbols used in GUIs for browsing content and executing functions.

2. Discussion of the Related Art

GUIs provide computer users, television viewers, video garners and other device users with a man machine interface. GUIs frequently feature icons, windows, hypertext or the like that allows a device user to access other GUIs (browse) or command a device to execute functions, such as launching a computer application, downloading a video, or selecting a character in a video game.

One challenge facing GUI designers is the limited display space available on a device display, such as a computer monitor or television set display. To address this problem, the GUI designer frequently provides a master GUI, such as a main menu GUI that features multiple icons, windows, hypertext or the like for browsing and executing functions. Usually, the icons and windows have an appearance or title that conveys an idea or theme. These icons and windows provide an implied invitation for the user to select one of the icons to receive more information related to the theme or execute a function related to the theme.

When a user selects a gateway icon or window, a new GUI appears on the display showing information (i.e. attributes) related to the theme of the selected icon. Often the new GUI features other icons or windows that invite the user once again to select one of the icons to receive even more detailed information. This layered presentation of GUIs each having their own icons and windows often leaves the user lost when browsing series of GUIs; each GUI having different menus and submenus with various icons and windows. The layered presentation also makes it easy for the user to lose context of the information the user is currently viewing. In short, the layered presentation of GUIs is an un-intuitive presentation of information from a human factors standpoint.

This problem can be seen, for example, with television display GUIs commonly used for selecting on-demand movies. Two common approaches to the design of these television GUIs highlights this problem.

In a first approach, a master GUI is presented to the user with a long list of movie titles. The list often extends from the top of the display to the bottom of the display with only a single movie title for each available movie being displayed to the viewer. The viewer using a remote control selects one of the movie titles. After selecting the movie title, a new GUI is displayed that shows more information related to the movie, for example the cast, director or a synopsis of the movie. The new GUI may even have further selections that allow the viewer to get even more detailed information. The viewer may then make a selection and choose to watch the movie or close the window and return to the master GUI that displayed the long list of movie titles. This layered approach to viewing information about the movie title is fragmented, making the movie browsing experience less than intuitive.

In a second approach, supplemental information about each movie is presented along with each title. One obvious problem with this approach is the limited viewing space on the television screen. Very little information can be co-displayed with each of the movie titles without cluttering the display or requiring tedious scrolling. In addition, the viewer must scroll or parse through a large amount of possibly unwanted information displayed with each movie. This also makes the movie browsing experience less than intuitive.

Those skilled in the art will recognized that there is a need for a more intuitive apparatus and method for displaying and browsing content related to a theme.

### SUMMARY OF THE INVENTION

Several embodiments of the invention address the need stated above as well as other needs by providing an apparatus and method for displaying information.

In one embodiment, the invention can be characterized as a method for displaying information, the steps of the method comprising: associating a three dimensional object having first, second and third faces, with a theme; populating the first face with a first icon that represents the theme; populating the second face with a second icon, the second icon representing a first attribute of the theme; populating the third face with a third icon, the third icon representing a second attribute of the theme; generating a first perspective view of a three dimensional object, the first perspective view having the first and second faces but not the third face; displaying the first perspective view on a portion of a display; receiving a command; generating a second perspective view of the three dimensional object, the second perspective view having the third face; removing the first perspective view from the display; and displaying the second perspective view on the portion of the display after removing the first perspective view from the display.

In another embodiment, the invention can be characterized as a method for selecting video on demand movies for display on a television, the method comprising; generating a plurality of polyhedrons, each polyhedron having a plurality of faces; populating a first face of each of the plurality of faces with a plurality of first icons, each of the first icons representing a different movie title; populating a second face of each of the plurality of faces with a second icon, each of the second icons having information about the movie represented on the first face; populating a third face of each of the plurality of faces with a third icon, the third icon having information about the movie represented on the first face; displaying the plurality of polyhedrons on the television, each of the polyhedrons arranged with the first and second faces visible and the third face hidden; emphasizing a first polyhedron of the plurality of the polyhedrons; receiving a first control signal from a remote device, the first control signal selecting another polyhedron; changing emphasis from the first polyhedron to a second polyhedron of the plurality of polyhedrons; receiving a second control signal from the remote device, the second control signal commanding a rotation of the second polyhedron; rotating the second polyhedron so that the third face of the second polyhedron is visible; and receiving a third control signal from a remote device, the third control signal commanding the television to begin playing the movie represented on the first face of the second polyhedron.

An apparatus for selecting media content, the apparatus comprising: a display for displaying media content and a plurality of objects, each of the plurality of objects associated with respective media content and each of the plurality of objects having a plurality of views for displaying information about the respective media content; a signal generating device for generating a signal to drive the display with media content and the plurality of objects; a media source connected with the signal generating device configured to provide the respective media content associated with each of the plurality of objects; and a control device in communication with the signal generating device operable to; select one of the plurality of objects displayed on the display, command the signal generating device to change the view of the selected object, and command the signal generating device to display the media content associated with the selected object on the display.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an illustration of an apparatus according to a first embodiment of the present invention.

FIG. 2 is an illustration of an apparatus according to a second embodiment of the present invention.

FIG. 3 is an illustration of a first exemplary GUI according to an embodiment of the present invention.

FIG. 4 is an illustration of three exemplary objects according to an embodiment of the present invention.

FIG. 5 is an illustration of a second exemplary GUI according to an embodiment of the present invention.

FIG. 6 is an illustration of a third exemplary GUI according to an embodiment of the present invention.

FIG. 7 is a second illustration of a fourth exemplary GUI according to an embodiment of the present invention.

FIG. 8 shows the steps of a method for displaying content according to a third embodiment of the present invention.

FIG. 9 shows a method for displaying content according to a fourth embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

To provide a more intuitive apparatus and method for browsing content, the concept of a multi-surfaced object is employed. Each face of the multi-surfaced object populated with an icon having attributes related to a unifying theme. For example, the multi-surfaced object may be a cube and represent a movie that is currently available for on demand viewing. One face of the cube may be populated with an icon of a movie poster showing the title of the film, conveniently conveying the theme of the cube. A second face of the cube may be populated with an icon showing the names and photos of the primary cast of the movie, providing the viewer with some attributes of the movie. A third face may be populated with an icon showing a synopsis of the movie, providing even more attributes of the movie.

Notably, each face of the multi-surfaced object can show icons that display different attributes related to a common theme. In this case, the theme is an on demand movie with icons displaying the movie attributes shown on each face of the cube. The cube, thus, provides the viewer with context for viewing information related to the movie.

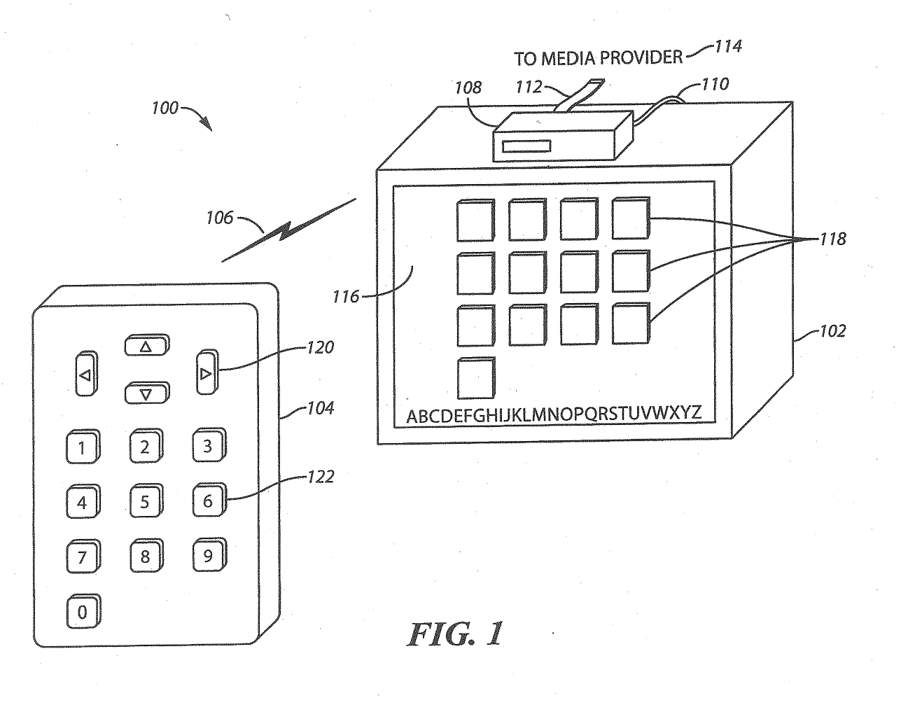

Referring to FIG. 1, an apparatus 100 according to a first embodiment of the present invention is shown.

The apparatus 100 includes a television 102 in communication with a control device 104 through a wireless connection 106. The television 102 is also connected with a signal generating device 108 through an output coaxial cable 110. The signal generating device 108 has an input coaxial cable 112 that connects with a media provider 114. The television has a display 116 showing a GUI with multiple objects 118. The control device 104 has a plurality of buttons 120 and a keypad 122.

The control device 104 sends signals to the signal generating device 108 through the wireless connection 106. The signal generating device 108 responds to the user inputs by sending a signal to the television 102 consistent with the user inputs. The user may, for example, use the buttons 120 to command the signal generating device 108 to select one of the multiple objects 118 shown on the display. The signal generating device 108 may respond to the command by sending a signal to the television 102 that emphasizes the selected object on the display 116.

Each of the multiple objects 118 shown on the display 116, represents a single perspective view of a three dimensional object. The displayed views of the multiple objects 118 can be controlled by the user through the control device 104. The multiple objects may be rotated using the buttons 120 revealing other faces of the three dimensional object. Each three dimensional object, represents a theme such as a specific Sony movie with the movie title and the movie poster image appearing on an icon displayed on a face of the object. Using the buttons 120, the user can rotate each of the multiple objects 118 to reveal other faces of each of the multiple objects 118. On each face, a different attribute icon of the respective movie appears.

The signal generating device 108 may also send signals to the media provider 114 that indicates inputs or selections by the user. For example the signal generating device 108 may send a signal to the media provider 114 that indicates the user has requested a specific on demand movie be sent from the media provider 114 for display on the television 102.

In this embodiment, the signal generating device 108 is connected with the media provider 114 through the input coaxial cable 112. In alternate embodiments, the connection between the signal generating device 108 and the media provider 114 is through a wireless link, a satellite connection, the internet or other data communication channel In this embodiment, the signal generating device 108 is collocated with the television 102. In alternate embodiments, the signal generating device 108 is not collocated with the television 102. For example the signal generating device 108 may be collocated with the media provider 114 or embedded in the television 102.

In this embodiment, the control device 104 is in wireless communication with the television 102. In alternate embodiments the control device 104 may be wired to the signal generating device 108 the television 102 or other system device.

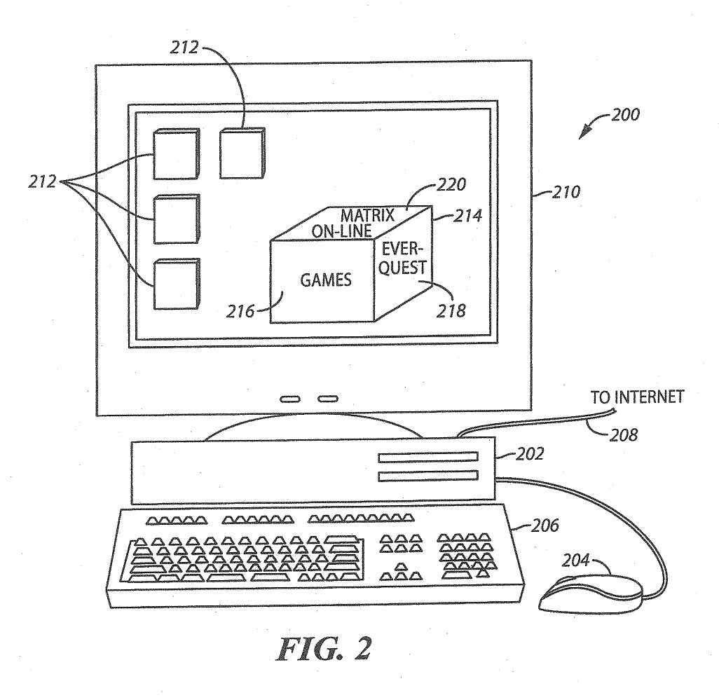

Referring next to FIG. 2, an apparatus 200 according to a second embodiment of the present invention is shown.

The apparatus 200 includes a computer 202 in communication with a mouse 204 and a keyboard 206. The computer 202 is also connected with the internet 208 and a display 210. The display 210 shows a plurality of objects 212 and a selected object 214. The selected object 214 has three faces 216 218 220 that are visible to a user.

The mouse 204 and keyboard 206 allow a user to control each of the plurality of objects 212. The plurality of objects 212 each appear as a perspective view of a three dimensional object such as a cube. The user may select one of the pluralities of objects 212 using the mouse 204 and keyboard. The computer 202 emphasizes the selected object 214 by increasing the size of the selected object 214 relative to the plurality of objects 212. The selected object 214 may be rotated using the mouse 204 or keyboard 206 allowing the viewer to see alternate perspective views of the selected object 214. For example, in this embodiment the selected object 214 appears as a cube with three faces 216 218 220 and the user may rotate the selected object 214 to reveal a fourth, fifth and sixth face.

The plurality of objects 212 provides a user with a context sensitive display of information. For instance, the selected object 214 has an icon displayed on a first face, the icon populated with the words “SONY GAMES”. The first face 216 relates the theme of the selected object 214 to a viewer, in this case Sony Games. The second face 218 shows a second icon populated with the words “EVERQUEST” and the third face 220 shows a third icon populated with the words “MATRIX ON LINE”. Thus the selected object 214 provides the user with a context apparent way to browse the Sony games available. The cube appearance of the selected object 214, visually invites the user to rotate the cube to find (browse) even more SONY games.

In this embodiment, the computer 202 emphasizes the selected object 214 by increasing the size of the selected object 214 relative to the plurality of objects 212. In alternate embodiments the selected object 214 is emphasized by highlighting, outlining, a change in color or by providing any other visual or audio cue. In this embodiment, the selected object 214 may be rotated using the mouse 204 or keyboard 206 allowing the view generate alternate perspective views of the selected object 214. In alternate embodiments alternate views are generated by generating new perspective views and replacing the original perspective view with the new perspective view. The generation of views that are not intrinsic to any real three dimensional objects, such as views of a three sided cube is also contemplated.

Those skilled in the art will recognize that the plurality of objects 212 may have icons, windows, hypertext or other GUI elements on each face. Some faces may allow a user to select the face and execute a function. Other faces may be informational allowing a user to browse information in a context apparent way. In some embodiments, an execute action such as a double mouse click on any face of the object will invoke the same function, such as downloading a video stream. In other embodiments, an execute action on a face of the object will execute face specific function such as launching the Matrix on line application or the Everquest application.

Other embodiments are also embraced through objects in other hardware architectures and software environments. For example those found in personal digital assistants, game players, and application specific computing devices such as those found with microwave ovens, automobile navigation systems and the like. Some of these architectures also feature application specific user interfaces such as joysticks, game paddles and the like.

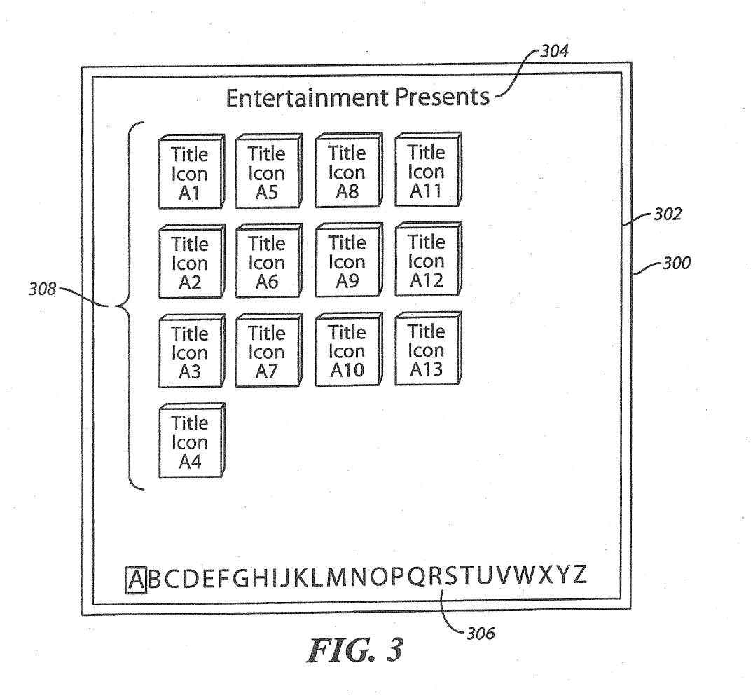

Referring next to FIGS. 3-7, for the purpose of drawing clarity, a shorthand notation is used. The shorthand notation is used for depicting movie icons that include the title of the movie and a still image for the movie. Specifically, a complete rendering of: Title icon A1 would show the title “A Chef in Love” and a still image from “A Chef in Love; Title icon A2 would show the title “All About my Mother” and a still image from “All About my Mother”, Title icon A3 would show the title “Art School Confidential” and a still image from “Art School Confidential”; Title icon A4 would show the title “A Pure Formality” and a still image from “A Pure Formality”; Title icon A5 would show the title “Across the Sea of Time” and a still image from “Across the Sea of Time”, Title icon A6 would show the title “All the Real Girls” and a still image from “All the Real Girls”; Title icon A7 would show the title “Autofocus” and a still image from “Autofocus”; Title icon A8 would show the title “A Friend of the Deceased” and a still image from “A Friend of the Deceased”; Title icon A9 would show the title “Amateur” and a still image from “Amateur”, Title icon A10 would show the title “American Hardcore” and a still image from “American Hardcore”; Title icon A11 would show the title “After Glow” and a still image from “After Glow”; Title icon A12 would show the title “American Movie” and a still image from “American Movie”, Title icon A13 would show the title “A Midwinter's Tale” and a still image from “A Midwinter's Tale”.

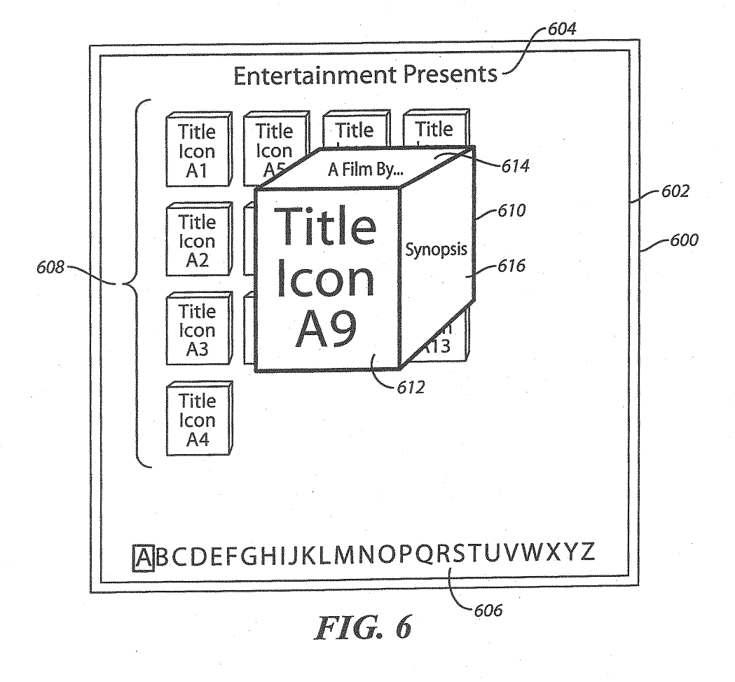

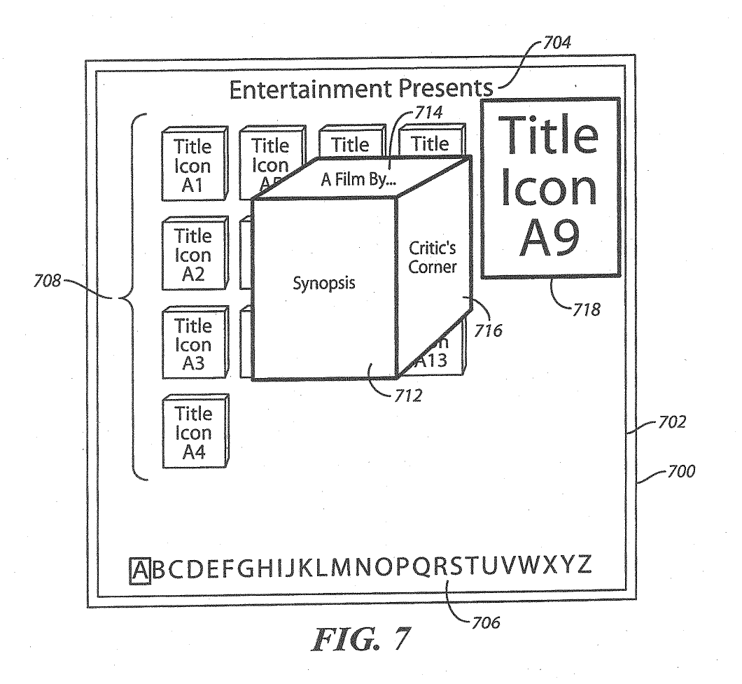

For FIGS. 6-7 a shorthand notation is also applied to some of the text. The words “A Film by . . . ” is shorthand for “A Film By Hal Hartley”. The words “Critics Corner” is shorthand for the beginning of a movie critique that reads “Critics Corner, Best Picture of the year”. The word “Synopsis” is shorthand for the beginning of a movie synopsis that reads “Synopsis—an ex-nun who believes that God has an as yet unspecified mission set aside for her, keeps herself fed by writing short stories for a pornographic magazine. One day she meets Thomas (Martin Donovan), a confused but insightful amnesiac wandering the streets of New York City”.

Referring next to FIG. 3, an illustration of a display 300 showing a first exemplary GUI 302 is shown.

The GUI 302 has a title bar 304 that displays “Sony Entertainment Presents”. The GUI 302 also has a navigation bar 306 that shows the letters of the alphabet. The remainder of the GUI shows a plurality of objects 308.

The GUI 302 space is devoted largely to the plurality of objects 308 on the display 300. The navigation bar 306 and the title bar 304 identify the class of themes that the each of the plurality of objects 308 that appear on the display 300 represents. In this case, the class of themes is Sony pictures that begin with the letter A, (e.g. A chef in love, A friend of the deceased, A Midwinter's tale, A Pure Formality, Across the sea of time etc.). Each of the plurality of objects 308 appears as a perspective view of a three dimensional object. In this case, each of the plurality of objects 308 appears as a three dimensional box with an appearance similar to a video box that might be displayed in a video rental store. The perspective view of each of the plurality of objects 308 shows a face bearing a poster image of each movie. This allows the viewer to quickly and easily browse the different movies. The three dimensional shape of the each of the plurality of objects 308 invites the user to select one of the objects and rotate it to get more information about the movie.

Those skilled in the art will recognize that there are many ways to present context information such as the information provided in the navigation bar 306 and the title bar 304. In alternate embodiments, the navigation bar 306, the title bar 304 or other indicators of theme class, group objects by, genre, director, game type, application type or any other logical groupings. Displaying all available objects on a single GUI without navigation bar or title bar or similar is also contemplated.

It can also be appreciated that much of the display 300 area is devoted to the objects and not to menu choices and selections. In addition, the use of a three dimensional object intuitively conveys to the viewer that more information related to the theme of the object is readily available by selecting and rotating the object. This GUI 302 might for example be used for selecting on demand movies. The GUI 302 provides the user with an intuitive display for easily browsing movies titles. The browsing experience provided by the GUI 302 is intuitive because it is somewhat similar to a browsing experience at a movie rental store.

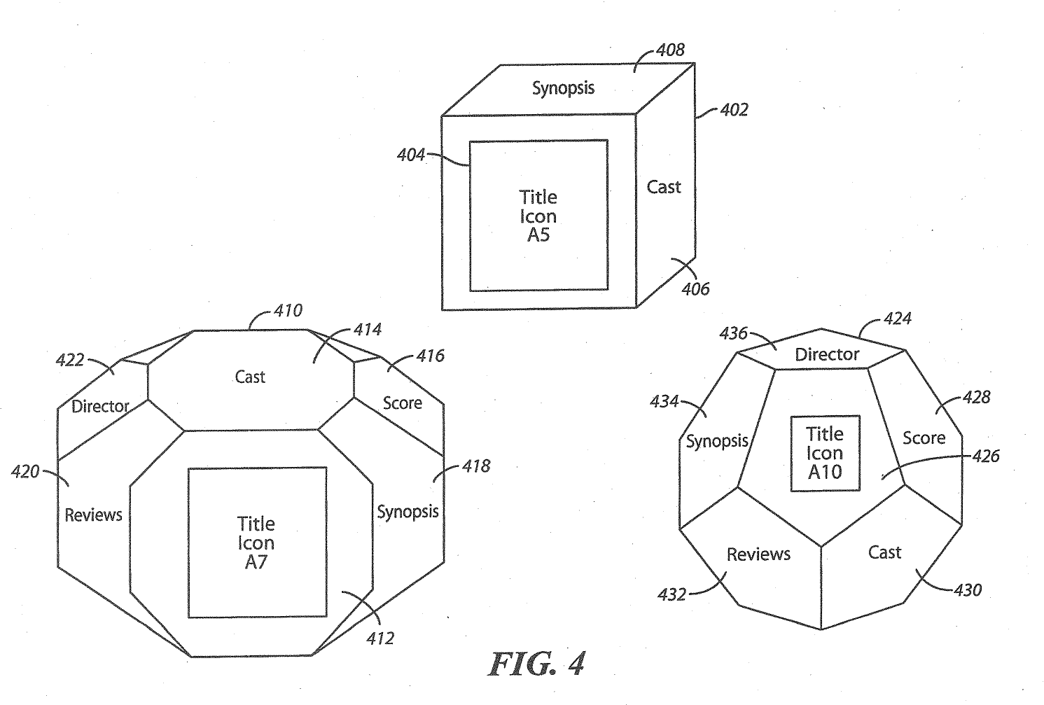

Referring next to FIG. 4, an illustration of three exemplary objects 402, 410, 424, according to embodiments of the present invention, are shown. Each of the exemplary objects 402, 410, 424 is a polyhedron having multiple faces.

The first object 402 is formed as a cube and is represented in perspective view. The first object 402 has a first face 404 that shows a movie poster representing the theme of the first object. In this case the theme is the movie “Across the Sea”. A second face 406 shows the cast of “Across the Sea”. A third face shows a synopsis of “Across the Sea”.

The second object 410 is formed as a ten sided polyhedron. The second object 410 has a first face 412 that shows a movie poster representing a theme of the second object 410. In this case, the theme is the movie “Autofocus”. A second face 414 shows the cast of “Autofocus”. A third face 416 shows the score of “Autofocus”. A fourth face 418 shows a synopsis of “Autofocus”. A fifth face 420 show reviews of “Autofocus”. A sixth face 422 shows the director of “Autofocus”.

The third object 424 is formed as a twelve sided polyhedron. The third object has a first face 426 that shows a movie poster representing the theme of the third object 424. In this case the theme is the movie “American Hardcore”. Also visible from this view is a second face 428 showing the score from “American Hardcore”. A third face 430 shows the cast from “American Hardcore”. A fourth face 432 shows reviews of “American Hardcore”. A fifth face shows a synopsis 434 of “American Hardcore” and a sixth face 436 shows the director of “American Hardcore”.

Each of the exemplary objects 402, 410, 424 provides an intuitive paradigm for viewing information. In this case, each of the objects has a theme (e.g. a movie title) with each faces of the object showing attributes of the theme. This allows a viewer to contextually browse information about each object without having to navigate a complex menu tree. Viewers intuitively know that different views of a three dimensional object are just different perspectives of the same object. Similarly, viewers viewing different perspectives of exemplary objects 402, 410, 424 intuitively know that information appearing on the faces of a single object is interrelated and thus there is likely to be a common theme running through the information.

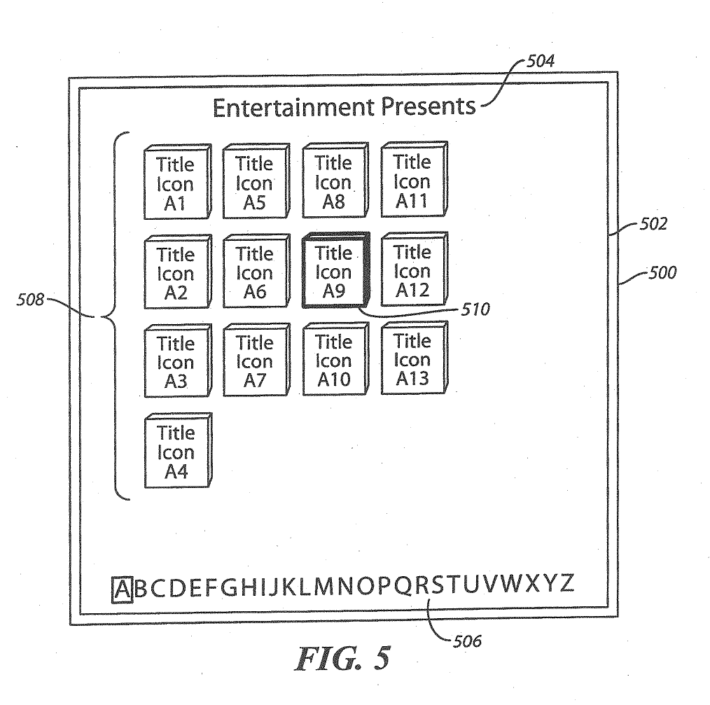

Referring next to FIG. 5, an illustration of a display 500 showing a second exemplary GUI 502 is shown.

The GUI 502 has a title bar 504 that displays “Sony Entertainment Presents”. The GUI 502 also has a navigation bar 506 that shows the letters of the alphabet. The majority of the GUI shows a plurality of objects 508. An emphasized object 510 appears among the plurality of objects.

The viewer can use a remote control, keyboard, mouse or other control device to emphasize any one of the plurality of objects 508. Selection of objects in one exemplary embodiment is accomplished by using scrolling arrows on a television remote control. In another exemplary embodiment, the objects are numbered and selected using a number keypad on a remote control device.

The emphasized object 510 is selected by a viewer as an object of interest. In this case, the object of interest is the movie “Amateur”. The viewer can rotate the emphasized object 510 using a remote control, keyboard, mouse or other control device to reveal more information on other faces of the emphasized object 510. This allows the viewer to browse information about the movie “Amateur” while also seeing the other films also available to the viewer. In one exemplary embodiment, the viewer rotates the emphasized object 510 by pressing the enter key on a remote control device to focus the remote control's scrolling arrows on the emphasized object 520. The user then can use the scrolling arrows to rotate the emphasized object 510.

The viewer may also execute a function related to the emphasized object 510 through a remote control, keyboard, mouse or other control instrument. For example, the viewer may command a signal generating device to begin executing a function of the emphasized object 510. In one exemplary embodiment, the viewer may command the television to begin playing the movie associated with the emphasized object 510. In this case the television would begin playing the movie “Amateur”.

Referring next to FIG. 6, an illustration of a display 600 showing a third exemplary GUI 602 is shown.

The GUI 602 has a title bar 604 that displays “Sony Entertainment Presents”. The GUI 602 has a navigation bar 606 that shows the letters of the alphabet. The majority of the GUI shows a plurality of objects 608. An emphasized object 610 appears among the plurality of objects.

The emphasized object 610 appears as an oversized object relative to remainder of the plurality of objects. The emphasized object 610 has a first face 612 having a movie poster of the movie “Amateur”. Thus, the theme of the emphasized object is the movie “Amateur”. A second face 614 conveys an attribute of the theme, in this case the producer of “Amateur”, Hal Hartley. A third face 616 contains another attribute of the theme, in this case a synopsis of “Amateur”.

A viewer can rotate the emphasized object using a control device. The emphasized object 610 appears as a three dimensional box inviting the user to use the control device to rotate the cube to reveal hidden faces of the cube, possibly containing more information that relates to the movie “Amateur”.

It should be noted that the large size of the emphasized object 610 allows easier viewing of information on the icon. The plurality of objects 608 is also present on the GUI 602 providing the viewer with context of the emphasized object 610.

It should be noted that in some embodiments object rotation may be constrained to certain directions to aid the user in rotating the object. For example, the emphasized object 610 may be constrained to rotating about coordinate axes that orthogonally penetrates each face of the object. In the case of a box like object, such constraints may make rotating the box to show a desired face easier with some control devices. In addition, successive rotations that result in upside down images or text may be constrained.

Referring next to FIG. 7, an illustration of a display 700 showing a third exemplary GUI 702 is shown.

The GUI 702 has a title bar 704 that displays “Sony Entertainment Presents”. The GUI 702 also has a navigation bar 706 that shows the letters of the alphabet. The majority of the GUI shows a plurality of objects 708. An emphasized object 710 appears among the plurality of objects.

The emphasized object 710 appears as an oversized object relative to remainder of the plurality of objects. The emphasized object 710 has a first face 712 having a movie synopsis of the movie “Amateur”. The theme of the emphasized object is the movie “Amateur”. A second face 714 conveys information about the producer of the movie, in this case Hal Hartley. A third face 716 contains a critical opinion of the movie “Amateur”.

Those skilled in the art may recognize that the emphasized object 710 is the same object as the emphasized of object shown in FIG. 6, after being rotated around a coordinate axis that extends orthogonally through the second face. The third face being a previously hidden face of the object shown in FIG. 6.

It should be noted that in some embodiments object rotation may be constrained to certain directions to aid the user in rotating the object. For example, the emphasized object 710 may be constrained to rotation about coordinate axes that orthogonally penetrate each face of the object. In the case of a box like object, such constraints may make rotating the box to show a desired face easier with some control devices. In addition, successive rotations that result in upside down images or text may be constrained.

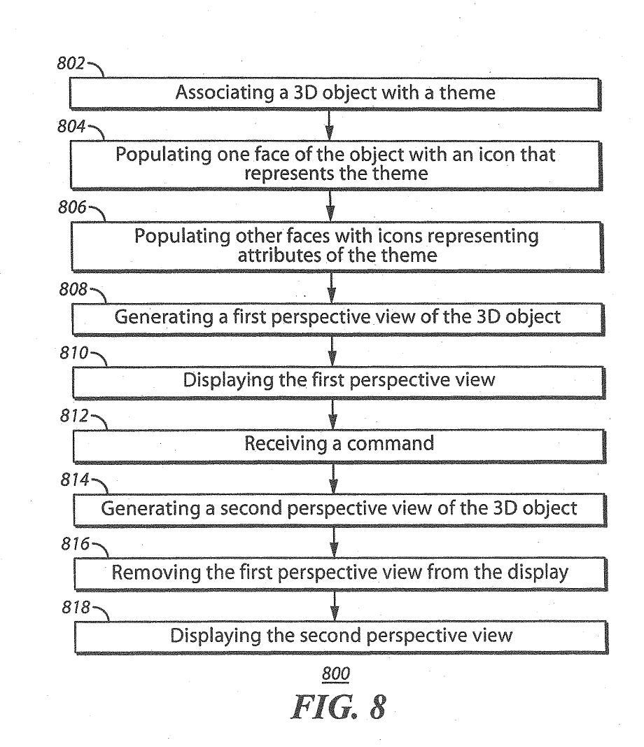

Referring next to FIG. 8, the steps of a method for displaying content according to an embodiment of the present invention are shown.

A three dimensional object is associated with a theme (Step 802). The three dimensional object is preferably a geometric shape with multiple faces. For example, the shape might be a cube, a box, a pyramid, or other polyhedron. The theme may be any theme related to information or functions. For example, the theme might be a movie, a maker of video games or a class of computer applications.

It should be apparent to those skilled in the art that the three dimensional object may be a concept and not necessarily a real object. That is, a geometric form from which perspective views may be generated and displayed.

One face of the object is populated with an icon that represents the theme (Step 804). Preferably the icon easily conveys the theme of the object to a viewer. For example, if the theme of the object is a movie, an icon having a movie poster with the movie title may be a good choice. If the theme of the object is available characters in a video game, an icon having a scene from the video game along with the video game title may be a suitable choice.

Other faces of the object are populated with icons representing attributes of the theme (Step 806). For example, if the theme of the object is a specific movie, other faces may be populated with icons showing the cast, the director, a synopsis of the movie. If the theme of the object is characters in a video game, each of the faces may be populated with pictures of the characters.

Next, a perspective view of the three dimensional object is generated (Step 808). Preferably the perspective view should prominently contain the face of the object that conveys the theme of the object.

The perspective view is displayed (Step 810). The perspective view may be displayed on a television screen, a computer monitor or the like. Preferably, the perspective view conveys to the viewer the shape of the three dimensional object and the theme of the object.

A command is received (Step 812). The command might for example be an input from a remote control device indicating that the viewer wishes to view another perspective of the three dimensional object.

A second perspective view of the three dimensional objects is generated (Step 814). The second perspective view might for example represent a coordinate rotation of the three dimensional object in a direction specified in the command of step 812.

Next, the first perspective view is removed from the display (Step 816).

The second perspective view is then shown on the display (Step 818). Notably, the second perspective view may show faces of the three dimensional object that are not shown in the first perspective view.

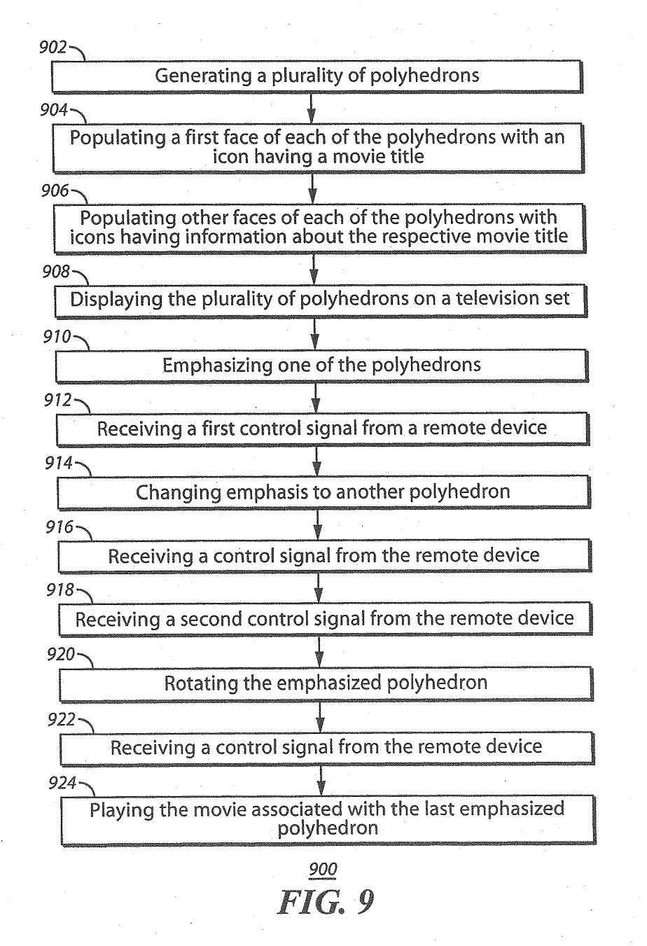

Referring next to FIG. 9, the steps of a method for displaying content according to an embodiment of the present invention are shown.

A plurality of polyhedrons is generated (Step 902). The polyhedrons might be a cube or a box for example. It should be apparent to those skilled in the art that the polyhedron may be a concept and not necessarily a real object. That is a geometric form that may be rotated and perspective views generated.

A first face of each of the polyhedrons is populated with an icon having a movie title, (Step 904).

Other faces of each of the polyhedrons are populated with icons having information about the respective movie title, (Step 906).

The plurality of polyhedrons is displayed on a television set, (Step 908). Preferably the first face of each of the polyhedrons is displayed for the viewer. This conveys the theme of the polyhedron to the viewer.

One of the polyhedrons is emphasized, (Step 910). This may be in response to a user selection or a default. The emphasis indicates that the polyhedron is the currently selected polyhedron.

A first control signal is received from a remote device, (Step 912). The signal might contain for example a command from a remote control device that indicates a selection of a new polyhedron. The command might contain an arrow key selection or a number corresponding to a polyhedron.

The emphasis is changed to a new polyhedron, (Step 914).

A control signal is received from the device, (Step 916). This control signal may indicate that the user is interested in the new polyhedron. The control signal might for example correspond to selecting an enter key on the remote control.

A second control signal is received from the device, (Step 918). This control signal might for example indicate that a user has commanded a rotation of the polyhedron.

The polyhedron is rotated, (Step 920).

A control signal from the remote device is received (Step 922). The signal may for example correspond with a play button selection on the remote device.

The movie associated with emphasized polyhedrons is played (Step 924).

While the invention herein disclosed has been described by means of specific embodiments, examples and applications thereof, numerous modifications and variations could be made thereto by those skilled in the art without departing from the scope of the invention set forth in the claims.

What is claimed is:

1. A method for selecting video on demand movies for display on a television, the method comprising;
generating a plurality of polyhedrons, each polyhedron having a plurality of faces;
populating a first face of each of the plurality of faces with a plurality of first icons, each of the first icons representing a different movie title;
populating a second face of each of the plurality of faces with a second icon, each of the second icons having information about the movie represented on the first face;
populating a third face of each of the plurality of faces with a third icon, the third icon having information about the movie represented on the first face;
displaying the plurality of polyhedrons on the television, each of the polyhedrons arranged with the first and second faces visible and the third face hidden;
emphasizing a first polyhedron of the plurality of the polyhedrons;
receiving a first control signal from a remote device, the first control signal selecting another polyhedron;
changing emphasis from the first polyhedron to a second polyhedron of the plurality of polyhedrons;
receiving a second control signal from the remote device, the second control signal commanding a rotation of the second polyhedron;
rotating the second polyhedron so that the third face of the second polyhedron is visible; and
receiving a third control signal from a remote device, the third control signal commanding the television to begin playing the movie represented on the first face of the second polyhedron.

2. An apparatus for selecting media content, the apparatus comprising:
a display for displaying media content and a plurality of objects, each of the plurality of objects associated with respective media content and each of the plurality of objects having a plurality of views for displaying information about the respective media content;
a signal generating device for generating a signal to drive the display with media content and the plurality of objects;
a media source connected with the signal generating device configured to provide the respective media content associated with each of the plurality of objects; and
a control device in communication with the signal generating device operable to;
select one of the plurality of objects displayed on the display,
command the signal generating device to change the view of the selected object, and
command the signal generating device to display the media content associated with the selected object on the display.

3. The apparatus of claim 3 wherein the plurality of views are static views.

4. The apparatus of claim 3 wherein a primary view of each of the plurality of views includes the title of a movie.

5. The apparatus of claim 3 wherein the control device is operable to command the signal generating device to select one of the plurality of objects and alter the signal from the signal generating device enlarging one of the plurality of objects displayed on the display.

6. The apparatus of claim 3 wherein when the control device is operable to command the signal generating device to select one of the plurality of objects and alter the signal from the signal generating device to emphasize one of the plurality of objects displayed on the display.

7. The apparatus of claim 3 wherein the media source is a cable television provider.

8. The apparatus of claim 3 wherein the media source is an internet source.
